(19) United States
(12) Patent Application Publication
(10) Pub. No.: US 2024/0029952 A1
(43) Pub. Date: Jan. 25, 2024

(54) INTEGRATED CO-FIRED INDUCTOR AND PREPARATION METHOD THEREFOR

(71) Applicant: HENGDIAN GROUP DMEGC MAGNETICS CO., LTD, Jinhua (CN)

(72) Inventors: Xianghua Han, Jinhua (CN); Cong Zhang, Jinhua (CN); Zhihong Jin, Jinhua (CN); Jun Xu, Jinhua (CN); Linke Wang, Jinhua (CN); Ning Zhang, Jinhua (CN)

(73) Assignee: HENGDIAN GROUP DMEGC MAGNETICS CO., LTD, Jinhua, OT (CN)

(21) Appl. No.: 18/255,538

(22) PCT Filed: Nov. 24, 2021
(86) PCT No.: PCT/CN2021/132664

§ 371 Date: Jun. 1, 2023

(30) Foreign Application Priority Data
Dec. 4, 2020 (CN) 202011412397.7
Dec. 4, 2020 (CN) 202022886600.6

(51) Int. Cl. H01F 41/02; H01F 27/255; H01F 27/28

(52) U.S. Cl. CPC H01F 41/0246; H01F 27/255; H01F 27/2823

(57) ABSTRACT

An integrated co-fired inductor and preparation method therefor, comprising: batch filling a magnetic powder in the mold cavity, embedding at least one wire into one layer of the magnetic powder, the two ends of the wire extending out of the mold cavity, sequentially performing compression molding and heat treatment to obtain a magnetic core, and bending and tinning the wire to obtain the co-fired inductor. The preparation method uses an integrated mold forming process to prepare the inductor to avoid an assembly process involving an excessive number of components; heat treatment is performed after the integral forming process, stress is fully released, material hysteresis loss is reduced, and the loss of the device under light load conditions is reduced; no extra gap exists between the wire and the magnetic core, air gaps are uniformly distributed within the magnetic core, and the vibration noise of eddy current loss is reduced.

### TECHNICAL FIELD

The present application belongs to the technical field of indicators and relates to an integrated co-fired inductor and a preparation method therefor.

### BACKGROUND

In recent years, with the large-scale use of devices such as mobile devices, home appliances, automobiles, industrial devices, data center servers, and communication base station servers, energy consumption has become a key consideration factor. With the continuous development of miniaturization, versatility, high performance and power saving of components, the electronic elements mounted on the components are required to be more miniaturized/thinned and to have higher performance. Improving the efficiency of a DC-DC converter and reducing heat generation are key conditions for the miniaturization of electronic elements. In particular, with the high-speed conversion of the IC of the DC-DC converter and the further development of the low impedance of the inductor used, the core power supply circuit is also increasingly required to be miniaturized/thinned and to have low DC impedance, large currents and high reliability.

At present, the use of the third-generation semiconductors as power devices has gradually become mainstream, and in particular, with gallium nitride (GaN) and silicon carbide (SiC) technologies becoming relatively mature, the third-generation semiconductors are suitable for manufacturing high-frequency and high-power devices that are resistant to high temperatures, high voltages and high currents. The power semiconductor is the main application field of the third-generation semiconductor. Gallium nitride has prominent advantages in high-frequency circuits and is very competitive in current mobile communications. The current application scenarios of gallium nitride are mainly concentrated in power amplifiers at base stations and military fields such as aerospace and have been gradually expanded to the consumer electronics field. Gallium nitride has the characteristics of high output power and high energy efficiency and thus can be present in a smaller volume at a given power level, so it can be applied in fast-charging power supply products. The physical properties of the silicon carbide material are superior to those of materials such as silicon. The band gap of the silicon carbide single crystal is about 3 times that of the silicon material, the thermal conductivity is 3.3 times that of the silicon material, the electron saturation migration speed is 2.5 times that of the silicon material, and the breakdown field strength is 5 times that of the silicon material. The silicon carbide material has irreplaceable advantages in high-power electronic devices that are resistant to high temperatures, high voltages and high currents. With the successful use of silicon carbide power semiconductors in high-end vehicle markets such as Tesla, the future automobile industry will become the major driver of the development of silicon carbide.

The power semiconductor is the core of electric energy conversion and circuit control in the electronic device and is the core part for achieving functions such as voltage conversion, frequency conversion, and DC-AC conversion in the electronic device. Power ICs, IGBTs, MOSFETs, and diodes are the four most widely used power semiconductor products. Electronic devices, such as inductors and capacitors, which work in coordination with power semiconductors to improve the power conversion efficiency of the power supply, also need to keep up with the development trend of the third-generation semiconductors. The inductor with high frequency, large currents, high saturation currents and high reliability is also an essential part of high-efficiency power supplies.

For conventional inductors with high current resistance, generally, a soft magnetic material is manufactured into discrete components, and a coil is placed on a magnetic core designed with air gaps to achieve the high-saturation superposed current of the induction device. Due to the requirements of achieving air gaps and components, the size of such inductors is often large, and especially, the thickness often exceeds 3 mm and even reaches 7 mm. The preceding problems are caused due to the characteristics of the soft magnetic ferrite material. Although the soft magnetic ferrite material has high permeability, the soft magnetic ferrite material is easily saturated in an external field because of its low saturation magnetic induction. To improve the saturation current resistance, air gaps need to be provided to reduce the effective permeability. The added air gaps increase the size of the device, and thus assembly and tolerance matching is required in the manufacturing process, causing some impact on the yield of product production.

Metal magnetic powder core materials have developed rapidly in recent years because of their high saturation magnetic induction intensity, high-temperature stability, impact resistance and low noise, especially in the field of integrated inductors, and the application of metal soft magnetic materials such as FeSiCr, carbonyl iron and iron nickel has advanced rapidly. The integrated inductor uses a metal soft magnetic material, and a coil is placed on a metal powder core and then integrally molded.

CN205230770U discloses a vertical slim heavy current inductor. The inductor includes an upper magnetic core, a lower magnetic core, and an inductor coil disposed between the upper magnetic core and the lower magnetic core. The inductor coil is wound by a flat metal copper wire, the upper and lower extended flat pins are bent to 90 degrees, and the two flat pins extend in opposite directions. The upper magnetic core is square. The lower magnetic core is provided with a groove for accommodating the inductor coil, and a positioning post for fixing the inductor coil is disposed in the middle of the groove. Such an induction element adopts a enameled wire as the coil due to the requirements of winding, and thus the molding pressure should not be excessively large. Otherwise, the insulation layer of the coil will be broken, causing the inter-layer short circuit. Further, due to the stress caused by the molding pressure, the magnetic core material generates stress anisotropy, increasing the material hysteresis loss. In view of the preceding problems, a DUI-type inductance product has been developed, in which a metal powder core is formed into a U sheet and an I sheet and fired as a magnetic powder core, and then a flat copper wire is clamped in the middle of the magnetic powder core to assemble an inductor.

CN110718359A discloses a structure and method for manufacturing a surface-mounted integrally-formed inductor. The structure includes two groups of identical pressing plate bodies pre-formed from a mixture of magnetic powder and thermosetting resin. Each pressing plate body has a press-fit surface having two high sides and a low middle. In a molding mold, the two groups of pressing plate bodies are placed directly above and below a built-in coil, respectively. The press-fit surfaces of the pressing plate bodies are required to face the built-in coil. The two poles of the built-in coil are required to extend beyond the two ends of the pressing plate bodies. The two groups of pressing plate bodies and the built-in coil are integrally formed into a blank body by pressurization or heating. After molding, the two poles of the built-in coil are exposed outside the blank body, and external electrodes are formed at both ends of the blank body.

However, when the inductor is manufactured in the preceding method, several components need to be assembled together, and extra air gaps can be easily introduced between the coil and the magnetic core, thereby reducing the effective magnetic permeability. Further, since a certain component needs to be formed into a sheet, the molding precision of the product is insufficient, and grinding processing is required, increasing the process cost and reducing the product yield.

### SUMMARY

The following is the summary of the subject matter described in detail herein. This summary is not intended to limit the scope of the claims.

In view of deficiencies in the prior art, the object of the present application is to provide an integrated co-fired inductor and a preparation method therefor. The preparation method provided by the present application uses an integrated molding process to prepare the inductor to avoid an assembly process involving an excessive number of components; heat treatment is performed after the integrated molding process, stress is fully released, material hysteresis loss is reduced, and the loss of the device under light load conditions is reduced; no extra gap exists between the wire and the magnetic core, air gaps are uniformly distributed within the magnetic core, and the vibration noise of eddy current loss is reduced.

To achieve the object, the present application adopts the technical solutions described below.

In a first aspect, the present application provides a preparation method of an integrated co-fired inductor. The preparation method includes the following steps:
filling magnetic powder into a mold cavity in batches, wherein adjacent two layers of magnetic powder are of different types, embedding at least one wire into one layer of magnetic powder, extending two ends of the wire out of the mold cavity, sequentially performing compression molding and heat treatment to obtain a magnetic core, and bending and tinning the wire extending out of the magnetic core to obtain a co-fired inductor.

The preparation method provided by the present application uses an integrated molding process to prepare the inductor to avoid an assembly process involving an excessive number of components; heat treatment is performed after the integrated molding process, stress is fully released, material hysteresis loss is reduced, and the loss of the device under light load conditions is reduced; no extra gap exists between the wire and the magnetic core, air gaps are uniformly distributed within the magnetic core, and the vibration noise of eddy current loss is reduced. Meanwhile, in the compression molding process, different types of powder are added in batches many times. In this manner, the deformation of the wire in the pressing process can be minimized, the anti-saturation ability of the magnetic core material can be improved, the respective advantages of different magnetic powder materials can be given full play, and the characteristics of the device can be better achieved. The cooperation of a soft magnetic material with a positive temperature coefficient and a soft magnetic material with a negative temperature coefficient can effectively improve the temperature stability of the device.

As a preferred technical solution of the present application, the magnetic powder is prepared by sequentially performing insulation coating, secondary coating and pelletizing treatment on soft magnetic powder to obtain the magnetic powder.

Preferably, the soft magnetic powder includes FeSiCr, FeSi, FeNi, FeSiAl, carbonyl iron powder, carbonyl iron nickel powder, FeNiMo, a Fe-based amorphous nanocrystalline material, a Co-based amorphous nanocrystalline soft magnetic material or a Ni-based amorphous nanocrystalline soft magnetic material.

As a preferred technical solution of the present application, a coating process used for the insulation coating includes phosphating, acidifying, oxidizing or nitriding, and further preferably, the insulation coating is performed on the soft magnetic powder by phosphating treatment.

The insulation coating involved in the present application refers to the coating process of a metal soft magnetic material to improve the insulativity and corrosion resistance of the surface of the metal soft magnetic powder and includes phosphating, acidifying, slow oxidizing, nitriding and other surface treatment. The improvement of the insulativity of the metal soft magnetic powder is mainly achieved by adding a high-resistivity powder material or growing a high-resistivity coating layer on the surface of metal soft magnetic particles in situ, involving materials such as silicon dioxide, aluminum oxide, magnesium oxide, kaolin, zirconium oxide, and mica powder. Different types of metal soft magnetic alloy powder are coated with different coating methods and coating processes to achieve the optimal coating effect.

Preferably, the phosphating treatment includes the following steps: the soft magnetic powder and diluted phosphoric acid are mixed, stirred, and dried to obtain phosphated soft magnetic powder.

Preferably, the phosphoric acid is diluted with acetone.

Preferably, a mass ratio of the phosphoric acid to the acetone is 1:(60-70) and may be, for example, 1:60, 1:61, 1:62, 1:63, 1:64, 1:65, 1:66, 1:67, 1:68, 1:69 or 1:70. However, the mass ratio of the phosphoric acid to the acetone is not limited to the listed values, and other unlisted values within the preceding value range are also applicable.

Preferably, the phosphoric acid and the acetone are mixed and stirred for 1-6 min, for example, 1 min, 2 min, 3 min, 4 min, 5 min or 6 min, and then allowed to stand for 5-10 min, for example, min, 6 min, 7 min, 8 min, 9 min or 10 min, for later use. However, the preceding time is not limited to the listed values, and other unlisted values within the preceding value range are also applicable.

Preferably, the soft magnetic powder and the diluted phosphoric acid are mixed and stirred for min, for example, 30 min, 35 min, 40 min, 45 min, 50 min, 55 min or 60 min. However, the preceding time is not limited to the listed values, and other unlisted values within the preceding value range are also applicable.

Preferably, a temperature for drying is 90-110° C. and may be, for example, 90° C., 92° C., 94° C., 96° C., 98° C., 100° C., 103° C., 104° C., 106° C., 108° C. or 110° C. However, the temperature for drying is not limited to the listed values, and other unlisted values within the preceding value range are also applicable.

Preferably, a time for drying is 1-1.5 h and may be, for example, 1.0 h, 1.1 h, 1.2 h, 1.3 h, 1.4 h or 1.5 h. However, the time for drying is not limited to the listed values, and other unlisted values within the preceding value range are also applicable.

As a preferred technical solution of the present application, the secondary coating includes the following steps: mixing and stirring a coating material and the soft magnetic powder obtained after insulation coating.

Preferably, the coating material is 2-10 wt % of the soft magnetic powder and may be, for example, 2 wt %, 3 wt %, 4 wt %, 5 wt %, 6 wt %, 7 wt %, 8 wt %, 9 wt % or 10 wt %. However, the preceding value is not limited to the listed values, and other unlisted values within the preceding value range are also applicable.

Preferably, the coating material includes phenolic resin, epoxy resin or silicone resin.

Preferably, the coating material and the soft magnetic powder are mixed and stirred for 40-60 min, for example, 40 min, 42 min, 44 min, 46 min, 48 min, 50 min, 52 min, 54 min, 56 min, 58 min or 60 min. However, the preceding time is not limited to the listed values, and other unlisted values within the preceding value range are also applicable.

As a preferred technical solution of the present application, the pelletizing treatment includes the following steps: pelletizing the soft magnetic powder obtained after the secondary coating, and basking, drying and cooling the pelletized soft magnetic powder to obtain the magnetic powder.

Preferably, the pelletizing is performed in a 40-60-mesh pelletizer. The pelletizer may be, for example, 40-mesh, 42-mesh, 44-mesh, 46-mesh, 48-mesh, 50-mesh, 52-mesh, 54-mesh, 56-mesh, 5-mesh or 60-mesh. However, the mesh size is not limited to the listed values, and other unlisted values within the preceding value range are also applicable.

Preferably, a time for basking is less than or equal to 3 h and may be, for example, 0.5 h, 1 h, 1.5 h, 2 h, 2.5 h or 3 h. However, the time for basking is not limited to the listed values, and other unlisted values within the preceding value range are also applicable.

Preferably, the soft magnetic powder after basking is sieved through a 30-50-mesh sieve and subsequently subjected to drying treatment. The screen may be, for example, 30-mesh, 32-mesh, 34-mesh, 36-mesh, 38-mesh, 40-mesh, 42-mesh, 44-mesh, 46-mesh, 48-mesh or 50-mesh.

However, the mesh size is not limited to the listed values, and other unlisted values within the preceding value range are also applicable.

Preferably, a temperature for drying is 50-70° C. and may be, for example, 50° C., 52° C., 54° C., 56° C., 58° C., 60° C., 62° C., 64° C., 66° C., 68° C. or 70° C. However, the temperature for drying is not limited to the listed values, and other unlisted values within the preceding value range are also applicable.

Preferably, a time for drying is 0.8-1.2 h and may be, for example, 0.8 h, 0.9 h, 1.0 h, 1.1 h or 1.2 h. However, the time for drying is not limited to the listed values, and other unlisted values within the preceding value range are also applicable.

Preferably, the cooling is natural cooling.

Preferably, the soft magnetic powder after cooling is sieved through a 30-50-mesh sieve, and an auxiliary material is added to the sieved soft magnetic powder to obtain the magnetic powder. The screen may be, for example, 30-mesh, 32-mesh, 34-mesh, 36-mesh, 38-mesh, 40-mesh, 42-mesh, 44-mesh, 46-mesh, 48-mesh or 50-mesh. However, the mesh size is not limited to the listed values, and other unlisted values within the preceding value range are also applicable.

Preferably, the auxiliary material includes magnesium oxide, lubricating powder or release powder.

As a preferred technical solution of the present application, first magnetic powder, second magnetic powder and the first magnetic powder are sequentially filled into the mold cavity in three batches.

Preferably, the wire is embedded into the second magnetic powder.

As a preferred technical solution of the present application, the wire is a bare wire without enameled wire.

Preferably, the wire is a copper wire.

Preferably, the wire is a flat wire with a rectangular cross section.

Preferably, the wire is a straight wire or a shaped wire.

Preferably, a shape of the shaped wire includes an S shape, an L shape, a U shape, a W shape or an E shape.

Preferably, the wire is laid side-by-side horizontally at intervals in one layer of magnetic powder.

Since the inductor designed in the present application requires low DC resistance and the copper wire needs to be subjected to heat treatment at a high temperature with the metal soft magnetic material, the flat copper wire without enameled wire is adopted for heat treatment at a high temperature to further reduce the loss of the powder core. The shape of the copper wire may also be designed according to requirements and includes an I shape, an S shape, an L shape, a U shape, a W shape and an E shape. A one-piece molding process may be used, or in-line compression molding may be performed by fixing a wire frame.

As a preferred technical solution of the present application, the compression molding is performed by hot pressing or cold pressing.

According to the characteristics of pelletized powder and the requirements of the inductor, hot pressing may be adopted. Hot pressing requires less pressure, the hot-pressed magnetic core and the wire can be in closer contact with less pressure required, but hot-pressing will reduce the pressing efficiency.

Preferably, a pressure for hot pressing is greater than or equal to 800 Mpa/cm², may be, for example, 800 Mpa/cm², 810 Mpa/cm², 820 Mpa/cm², 830 Mpa/cm², 840 Mpa/cm², 850 Mpa/cm², 860 Mpa/cm², 870 Mpa/cm², 880 Mpa/cm², 890 Mpa/cm² or 900 Mpa/cm², and further preferably, is 2000 MPa/cm².

In the present application, since no limitation of the enameled wire exists, the molding pressure of the magnetic powder may be used to obtain a magnetic core with a higher density. The pressure is preferably greater than 800 Mpa/cm² and even can reach 2000 MPa/cm². The best pressure suitable for the inductor is selected according to the service life of the mold and the capability of the press.

Preferably, a temperature for hot pressing is 90-180° C. and may be, for example, 90° C., 100° C., 110° C., 120° C., 130° C., 140° C., 150° C., 160° C., 170° C. or 180° C. However, the temperature for hot pressing is not limited to the listed values, and other unlisted values within the preceding value range are also applicable.

Preferably, a time for hot pressing is 5-100 s and may be, for example, 5 s, 10 s, 20 s, 30 s, 40 s, s, 60 s, 70 s, 80 s, 90 s or 100 s. However, the time for hot pressing is not limited to the listed values, and other unlisted values within the preceding value range are also applicable.

Preferably, the heat treatment is annealing treatment.

Preferably, the heat treatment is performed in a protective atmosphere.

Preferably, a gas used for the protective atmosphere is nitrogen and/or an inert gas.

Preferably, a temperature for the heat treatment is 650-850° C. and may be, for example, 650° C., 660° C., 670° C., 680° C., 690° C., 700° C., 710° C., 720° C., 730° C., 740° C., 750° C., 760° C., 770° C., 780° C., 790° C., 800° C., 910° C., 920° C., 930° C., 940° C. or 950° C. However, the temperature for the heat treatment is not limited to the listed values, and other unlisted values within the preceding value range are also applicable.

Preferably, a time for the heat treatment is 30-50 min and may be, for example, 30 min, 32 min, 34 min, 36 min, 38 min, 40 min, 42 min, 44 min, 46 min, 48 min or 50 min. However, the time for the heat treatment is not limited to the listed values, and other unlisted values within the preceding value range are also applicable.

In the present application, the heat treatment is performed on the pressed green inductor to densify the magnetic core, thereby obtaining higher saturation magnetic induction intensity, higher permeability and lower loss and improving the intensity of the inductor device. Different heat treatment temperatures are selected for different types of materials. For example, for amorphous metal soft magnetic powder such as FeSiB, FeSiBCr, FeNiSiBPC and the like, the temperature of the heat treatment cannot exceed the crystallization temperature of the powder; for nanocrystalline metal soft magnetic alloy powder, the temperature of the heat treatment needs to be higher than the crystallization temperature but not higher than the grain growth temperature, and the specific temperature of the heat treatment needs be set according to the curve measured by a differential scanning calorimeter; for soft magnetic powder such as gas-atomized, water-atomized, gas-and-water-atomized or multi-stage-atomized FeSiAl, FeNi, FeNiMo and FeSi, high-temperature treatment needs to be performed according to the combination of powder, and the temperature of the heat treatment is higher than 650° C. and lower than 850° C. The heat treatment may be performed under the protection of an inert gas such as nitrogen and argon or may be performed under the protection of a reducing gas such as hydrogen and a hydrogen/nitrogen mixed gas. Since the wire without enameled wire is adopted in the present application and the wire is I-shaped, S-shaped, L-shaped, U-shaped, W-shaped and E-shaped, the wires are not in contact with each other, and no short circuit problem between wires exists.

In a second aspect, the present application provides a co-fired inductor prepared by the preparation method described in the first aspect. The co-fired inductor includes a magnetic core and at least one wire located in the magnetic core. The magnetic core includes at least two magnetic powder layers sequentially stacked, and magnetic powder in adjacent two magnetic powder layers is of different types. The wire is located in one magnetic powder layer, two ends of the wire extend out of the magnetic core, and the wire extending out of the magnetic core is bent to adhere to the outer wall of the magnetic core.

As a preferred technical solution of the present application, the wire is a bare wire without enameled wire.

Preferably, the wire is a copper wire.

Preferably, the wire is a flat wire with a rectangular cross section.

Preferably, the wire is a straight wire or a shaped wire.

Preferably, a shape of the shaped wire includes an S shape, an L shape, a U shape, a W shape or an E shape.

Preferably, the wire is laid side-by-side horizontally at intervals in one layer of magnetic powder.

Compared with the prior art, the present application has the beneficial effects described below.

The preparation method provided by the present application uses an integrated molding process to prepare the inductor to avoid an assembly process involving an excessive number of components; heat treatment is performed after the integrated molding process, stress is fully released, material hysteresis loss is reduced, and the loss of the device under light load conditions is reduced; no extra gap exists between the wire and the magnetic core, air gaps are uniformly distributed within the magnetic core, and the vibration noise of eddy current loss is reduced. Meanwhile, in the compression molding process, different types of powder are added in batches many times. In this manner, the deformation of the wire in the pressing process can be minimized, the anti-saturation ability of the magnetic core material can be improved, the respective advantages of different magnetic powder materials can be given full play, and the characteristics of the device can be better achieved. The cooperation of a soft magnetic material with a positive temperature coefficient and a soft magnetic material with a negative temperature coefficient can effectively improve the temperature stability of the device.

Other aspects can be understood after the detailed description is read and understood.

### BRIEF DESCRIPTION OF DRAWINGS

FIG. 1 is a structure diagram of a co-fired inductor prepared in Example 1 of the present application;

FIG. 2 is a structure diagram of a co-fired inductor prepared in Example 2 of the present application;

FIG. 3 is a structure diagram of a co-fired inductor prepared in Example 3 of the present application;

FIG. 4 is a structure diagram of a co-fired inductor prepared in Example 4 of the present application;

FIG. 5 is a structure diagram of a co-fired inductor prepared in Example 5 of the present application;

in the figures, 1—wire; 2—first magnetic powder layer; 3—second magnetic powder layer; 4—third magnetic powder layer; 5—fourth magnetic powder layer; 6—fifth magnetic powder layer.

### DETAILED DESCRIPTION

It is to be understood that in the description of the present application, orientations or position relations indicated by terms such as “center”, “longitudinal”, “lateral”, “upper”, “lower”, “front”, “back”, “left”, “right”, “vertical”, “horizontal”, “top”, “bottom”, “in” and “out” are those based on the drawings. These orientations or position relations are intended to facilitate and simplify the description of the present application and are not to indicate or imply that a device or element referred to must have a particular orientation or must be constructed or operated in a particular orientation. Thus, these orientations or position relations are not to be construed as limiting the present application. Additionally, terms such as “first” and “second” are merely for description and are not to be construed as indicating or implying relative importance or implicitly indicating the number of technical features as indicated. Thus, a feature defined as a “first” feature or a “second” feature may explicitly or implicitly include one or more of such features. In the description of the present application, unless otherwise noted, the term “a plurality of” or “multiple” means two or more.

It is to be noted that in the description of the present application, unless otherwise expressly specified and limited, the term “arranged”, “connected to each other” or “connected” is to be construed in a broad sense, for example, as securely connected, detachably connected or integrated; mechanically connected or electrically connected; directly connected to each other or indirectly connected to each other via an intermediary; or internally connected between two components. For those of ordinary skill in the art, specific meanings of the preceding terms in the present application may be construed according to specific circumstances.

The technical solutions of the present application are further described hereinafter through embodiments in conjunction with the drawings.

### Example 1

This example provides a preparation method of an integrated co-fired inductor. The preparation method specifically includes the following steps.

(1) 0.2 g of first magnetic powder was filled into a mold cavity, a flat copper wire 1 with a rectangular cross section was placed on the surface of the first magnetic powder after the enameled wire was removed, and two ends of the wire 1 were extended out of the mold cavity, wherein the wire 1 was a straight wire 1 with a length of 14 mm, a width of 2.6 mm and a thickness of 0.3 mm. The mold cavity was oscillated, the wire 1 was embedded into the first magnetic powder, and the first magnetic powder was smoothed. Then, 0.6 g of second magnetic powder was filled into the mold cavity, the mold cavity was oscillated, and the second magnetic powder was smoothed. Finally, 0.2 g of first magnetic powder was filled into the mold cavity, the mold cavity was oscillated, and the first magnetic powder was smoothed.

(2) The magnetic powder filled into the mold cavity was molded by hot pressing, wherein a pressure for hot pressing was 300 Mpa/cm², a temperature for hot pressing was 180° C., and a time for hot pressing was 30 s.

(3) After molding, annealing heat treatment was performed in a nitrogen atmosphere to obtain a magnetic core, wherein a temperature for the heat treatment was 700° C., and a time for the heat treatment was 30 min.

(4) Impregnation spraying, bending and tinning were sequentially performed on the wire 1 extending out of the magnetic core to obtain a co-fired inductor with a size of 11.0 mm×5.0 mm×2.0 mm, wherein the impregnation treatment was vacuum impregnation, and the spraying solution used in the spraying process was epoxy resin.

The first magnetic powder in step (1) was prepared in the following method.

(a) Insulation coating: the phosphoric acid was diluted by acetone, wherein a mass ratio of the phosphoric acid to the acetone was 1:60; the phosphoric acid and the acetone were mixed and stirred for 1 min and then allowed to stand for 5 min for later use; FeSi soft magnetic powder with D50=20 μm and the diluted phosphoric acid were mixed and stirred for 30 min and then dried at 90° C. for 1 h to obtain the phosphated soft magnetic powder.

(b) Secondary coating: a coating material and the soft magnetic powder obtained in step (c) were mixed and stirred for 40 min, wherein the coating material was 2 wt % of the soft magnetic powder, and the coating material was phenolic resin.

(c) Pelletizing treatment: the soft magnetic powder obtained after the secondary coating was pelletized in a 40-mesh pelletizer, the pelletized soft magnetic powder was basked for 2 h, the basked soft magnetic powder was sieved through a 30-mesh sieve, dried at 50° C. for 0.8 h, naturally cooled and sieved through a 30-mesh sieve, and magnesium oxide was added to the sieved soft magnetic powder to obtain the first magnetic powder.

The second magnetic powder was prepared with the same operation steps and process parameters as the first magnetic powder. The difference is that the soft magnetic powder adopted in step (a) was replaced with FeSiAl magnetic powder. Insulation coating, secondary coating and pelletizing treatment were also sequentially performed on the FeSiAl magnetic powder to obtain the second magnetic powder, and the process parameters adopted in each operation step were completely the same.

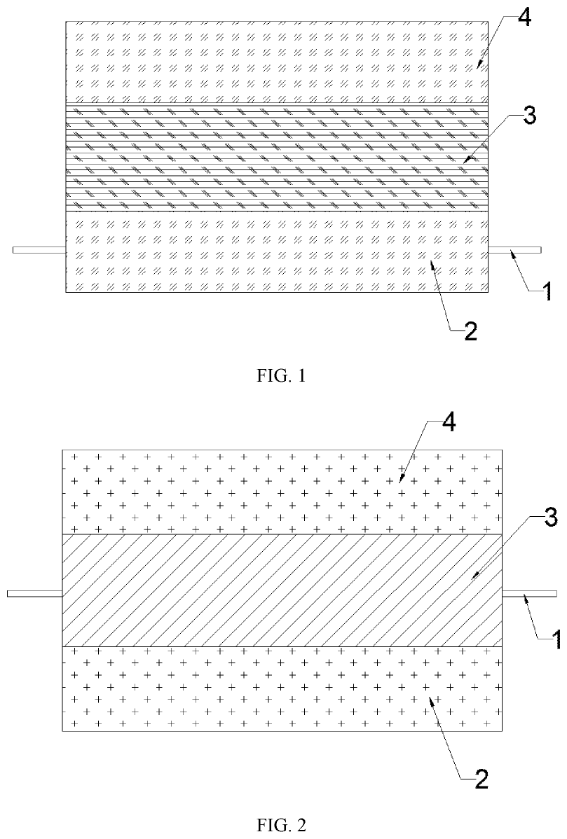

As shown in FIG. 1, in the prepared co-fired inductor, the first magnetic powder layer 2, the second magnetic powder layer 3 and the third magnetic powder layer 4 were formed by sequentially filling the first magnetic powder, the second magnetic powder and the first magnetic powder into the mold cavity, respectively, and the wire 1 was located in the first magnetic powder layer 2. The inductance characteristics of the prepared co-fired inductor were tested. The tested initial inductance L(0 A) was 150 nH, the saturation current was 90 A, and the temperature rise current was 85 A. The efficiency was tested by a 12 V-1 V step-down circuit. When the frequency of the switching power supply was 500 kHz, the efficiency reached 81.5% when the electronic load was 5 A, and the efficiency reached 90.3% when the electronic load was 25 A.

### Example 2

This example provides a preparation method of an integrated co-fired inductor. The preparation method specifically includes the following steps.

(1) 0.3 g of first magnetic powder was filled into a mold cavity, the mold cavity was oscillated, and the first magnetic powder was smoothed. Then, 0.5 g of second magnetic powder was filled, a flat copper wire 1 with a rectangular cross section was placed on the surface of the second magnetic powder after the enameled wire was removed, and two ends of the wire 1 were extended out of the mold cavity, wherein the wire 1 was an S-shaped wire with a length of 10 mm, a width of 2.6 mm and a thickness of 0.3 mm. The mold cavity was oscillated, the wire 1 was embedded into the second magnetic powder, and the second magnetic powder was smoothed. Finally, 0.3 g of first magnetic powder was filled, the mold cavity was oscillated, and the first magnetic powder was smoothed.

(2) The magnetic powder filled into the mold cavity was molded by hot pressing, wherein a pressure for hot pressing was 400 Mpa/cm², a temperature for hot pressing was 180° C., and a time for hot pressing was 30 s.

(3) After molding, annealing heat treatment was performed in an inert atmosphere to obtain a magnetic core, wherein a temperature for the heat treatment was 650° C., and a time for the heat treatment was 50 min.

(4) Impregnation spraying, bending and tinning were sequentially performed on the wire 1 extending out of the magnetic core to obtain a co-fired inductor with a size of 8.0 mm×6.0 mm×1.9 mm, wherein the impregnation treatment was vacuum impregnation, and the spraying solution used in the spraying process was epoxy resin.

The first magnetic powder in step (1) was prepared in the following method.

(a) Insulation coating: the phosphoric acid was diluted by acetone, wherein a mass ratio of the phosphoric acid to the acetone was 1:63; the phosphoric acid and the acetone were mixed and stirred for 3 min and then allowed to stand for 6 min for later use; FeNi soft magnetic powder and the diluted phosphoric acid were mixed and stirred for 40 min and then dried at 95° C. for 1.2 h to obtain the phosphated soft magnetic powder.

(b) Secondary coating: a coating material and the soft magnetic powder obtained in step (c) were mixed and stirred for 45 min, wherein the coating material was 5 wt % of the soft magnetic powder, and the coating material was epoxy resin.

(c) Pelletizing treatment: the soft magnetic powder obtained after the secondary coating was pelletized in a 43-mesh pelletizer, the pelletized soft magnetic powder was basked for 2.3 h, the basked soft magnetic powder was sieved through a 35-mesh sieve, dried at 55° C. for 1 h, naturally cooled and sieved through a 35-mesh sieve, and lubricating powder was added to the sieved soft magnetic powder to obtain the first magnetic powder.

The second magnetic powder was prepared with the same operation steps and process parameters as the first magnetic powder. The difference is that the soft magnetic powder adopted in step (a) was replaced with FeSiAl soft magnetic powder. Insulation coating, secondary coating and pelletizing treatment were also sequentially performed on the FeSiAl soft magnetic powder to obtain the second magnetic powder, and the process parameters adopted in each operation step were completely the same.

As shown in FIG. 2, in the prepared co-fired inductor, the first magnetic powder layer 2, the second magnetic powder layer 3 and the third magnetic powder layer 4 were formed by sequentially filling the first magnetic powder, the second magnetic powder and the first magnetic powder into the mold cavity, respectively, and the wire 1 was located in the second magnetic powder layer 3. The inductance characteristics of the prepared co-fired inductor were tested. The tested initial inductance L(0 A) was 160 nH, the saturation current was 95 A, and the temperature rise current was 90 A. The efficiency was tested by a 12 V-1 V step-down circuit. When the frequency of the switching power supply was 500 kHz, the efficiency reached 81.6% when the electronic load was 5 A, and the efficiency reached 90.6% when the electronic load was 25 A.

### Example 3

This example provides a preparation method of an integrated co-fired inductor. The preparation method specifically includes the following steps.

(1) 0.2 g of first magnetic powder was filled into a mold cavity, the mold cavity was oscillated, and the first magnetic powder was smoothed. Then, 0.6 g of second magnetic powder was filled, the mold cavity was oscillated, and the second magnetic powder was smoothed. Finally, 0.2 g of first magnetic powder was filled, a flat copper wire 1 with a rectangular cross section was placed on the surface of the first magnetic powder after the enameled wire was removed, and two ends of the wire 1 were extended out of the mold cavity, wherein the wire 1 was a W-shaped wire with a length of 18 mm, a width of 2.8 mm and a thickness of 0.26 mm. The mold cavity was oscillated, the wire 1 was embedded into the first magnetic powder, and the first magnetic powder was smoothed.

(2) The magnetic powder filled into the mold cavity was molded by hot pressing, wherein a pressure for hot pressing was 400 Mpa/cm², a temperature for hot pressing was 180° C., and a time for hot pressing was 30 s.

(3) After molding, annealing heat treatment was performed in a nitrogen atmosphere to obtain a magnetic core, wherein a temperature for the heat treatment was 690° C., and a time for the heat treatment was 40 min.

(4) Impregnation spraying, bending and tinning were sequentially performed on the wire 1 extending out of the magnetic core to obtain a co-fired inductor with a size of 7.5 mm×6.5 mm×1.8 mm, wherein the impregnation treatment was vacuum impregnation, and the spraying solution used in the spraying process was epoxy resin.

The first magnetic powder in step (1) was prepared in the following method.

(a) Insulation coating: the phosphoric acid was diluted by acetone, wherein a mass ratio of the phosphoric acid to the acetone was 1:65; the phosphoric acid and the acetone were mixed and stirred for 5 min and then allowed to stand for 8 min for later use; Fe powder with D50=10 μm and the diluted phosphoric acid were mixed and stirred for 50 min and then dried at 100° C. for 1.3 h to obtain the phosphated soft magnetic powder.

(b) Secondary coating: a coating material and the soft magnetic powder obtained in step (c) were mixed and stirred for 55 min, wherein the coating material was 7 wt % of the soft magnetic powder, and the coating material was silicone resin.

(c) Pelletizing treatment: the soft magnetic powder obtained after the secondary coating was pelletized in a 50-mesh pelletizer, the pelletized soft magnetic powder was basked for 2.5 h, the basked soft magnetic powder was sieved through a 40-mesh sieve, dried at 63° C. for 1.1 h, naturally cooled and sieved through a 40-mesh sieve, and release powder was added to the sieved soft magnetic powder to obtain the first magnetic powder.

The second magnetic powder was prepared with the same operation steps and process parameters as the first magnetic powder. The difference is that the soft magnetic powder adopted in step (a) was replaced with FeSiAl soft magnetic powder. Insulation coating, secondary coating and pelletizing treatment were also sequentially performed on the FeSiAl soft magnetic powder to obtain the second magnetic powder, and the process parameters adopted in each operation step were completely the same.

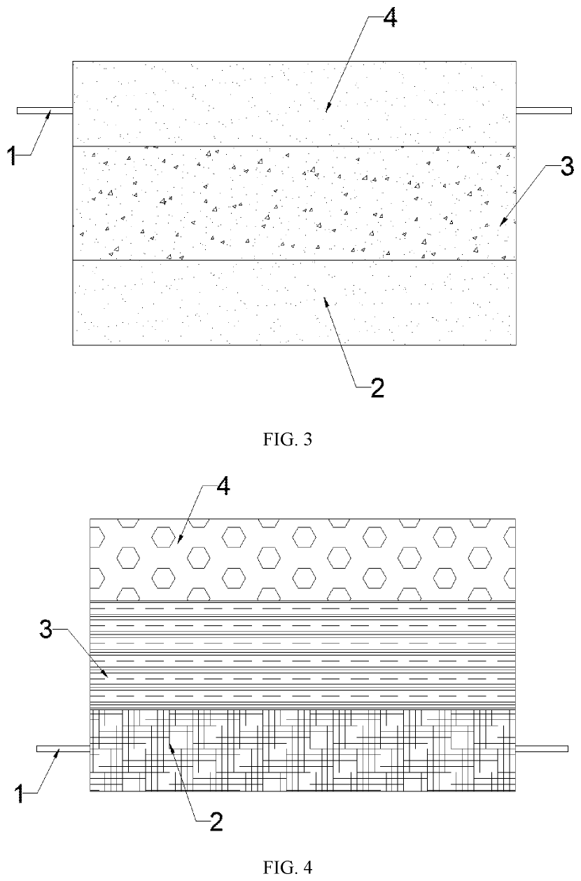

As shown in FIG. 3, in the prepared co-fired inductor, the first magnetic powder layer 2, the second magnetic powder layer 3 and the third magnetic powder layer 4 were formed by sequentially filling the first magnetic powder, the second magnetic powder and the first magnetic powder into the mold cavity, respectively, and the wire 1 was located in the third magnetic powder layer 4. The inductance characteristics of the prepared co-fired inductor were tested. The tested initial inductance L(0 A) was 150 nH, the saturation current was 100 A, and the temperature rise current was 90 A. The efficiency was tested by a 12 V-1 V step-down circuit. When the frequency of the switching power supply was 500 kHz, the efficiency reached 80.8% when the electronic load was 5 A, and the efficiency reached 91.2% when the electronic load was 25 A.

### Example 4

This example provides a preparation method of an integrated co-fired inductor. The preparation method specifically includes the following steps.

(1) 0.2 g of first magnetic powder was filled into a mold cavity, a flat copper wire 1 with a rectangular cross section was placed on the surface of the first magnetic powder after the enameled wire was removed, and two ends of the wire 1 were extended out of the mold cavity, wherein the wire 1 was a straight wire 1 with a length of 10 mm, a width of 2.0 mm and a thickness of 0.36 mm. The mold cavity was oscillated, the wire 1 was embedded into the first magnetic powder, and the first magnetic powder was smoothed. Then, 0.6 g of second magnetic powder was filled into the mold cavity, the mold cavity was oscillated, and the second magnetic powder was smoothed. Finally, 0.2 g of third magnetic powder was filled into the mold cavity, the mold cavity was oscillated, and the third magnetic powder was smoothed.

(2) The magnetic powder filled into the mold cavity was molded by cold pressing, wherein a pressure for cold pressing was 500 Mpa/cm², a temperature for cold pressing was 180° C., and a time for cold pressing was 30 s.

(3) After molding, annealing heat treatment was performed in a nitrogen atmosphere to obtain a magnetic core, wherein a temperature for the heat treatment was 850° C., and a time for the heat treatment was 30 min.

(4) Impregnation spraying, bending and tinning were sequentially performed on the wire 1 extending out of the magnetic core to obtain a co-fired inductor with a size of 8.0 mm×5.0 mm×3.0 mm, wherein the impregnation treatment was vacuum impregnation, and the spraying solution used in the spraying process was epoxy resin.

The first magnetic powder in step (1) was prepared in the following method.

(a) Insulation coating: the phosphoric acid was diluted by acetone, wherein a mass ratio of the phosphoric acid to the acetone was 1:70; the phosphoric acid and the acetone were mixed and stirred for 6 min and then allowed to stand for 10 min for later use; FeNi powder with D50=10 μm and the diluted phosphoric acid were mixed and stirred for 60 min and then dried at 110° C. for 1.5 h to obtain the phosphated soft magnetic powder.

(b) Secondary coating: a coating material and the soft magnetic powder obtained in step (c) were mixed and stirred for 60 min, wherein the coating material was 10 wt % of the soft magnetic powder, and the coating material was silicone resin.

(c) Pelletizing treatment: the soft magnetic powder obtained after the secondary coating was pelletized in a 60-mesh pelletizer, the pelletized soft magnetic powder was basked for 3 h, the basked soft magnetic powder was sieved through a 50-mesh sieve, dried at 70° C. for 1.2 h, naturally cooled and sieved through a 50-mesh sieve, and magnesium oxide was added to the sieved soft magnetic powder to obtain the first magnetic powder.

The second magnetic powder was prepared with the same operation steps and process parameters as the first magnetic powder. The difference is that the soft magnetic powder adopted in step (a) was replaced with FeSiAl soft magnetic powder. Insulation coating, secondary coating and pelletizing treatment were also sequentially performed on the FeSiAl soft magnetic powder to obtain the second magnetic powder, and the process parameters adopted in each operation step were completely the same.

The third magnetic powder was prepared with the same operation steps and process parameters as the first magnetic powder. The difference is that the soft magnetic powder adopted in step (a) was replaced with FeSi soft magnetic powder with D50=20 μm. Insulation coating, secondary coating and pelletizing treatment were also sequentially performed on the FeSi soft magnetic powder to obtain the third magnetic powder, and the process parameters adopted in each operation step were completely the same.

As shown in FIG. 4, in the prepared co-fired inductor, the first magnetic powder layer 2, the second magnetic powder layer 3 and the third magnetic powder layer 4 were formed by sequentially filling the first magnetic powder, the second magnetic powder and the third magnetic powder into the mold cavity, respectively, and the wire 1 was located in the first magnetic powder layer 2. The inductance characteristics of the prepared co-fired inductor were tested. The tested initial inductance L(0 A) was 120 nH, the saturation current was 70 A, and the temperature rise current was 65 A. The efficiency was tested by a 12 V-1 V step-down circuit. When the frequency of the switching power supply was 500 kHz, the efficiency reached 79.5% when the electronic load was 5 A, and the efficiency reached 88.3% when the electronic load was 25 A.

### Example 5

This example provides a preparation method of an integrated co-fired inductor. The preparation method specifically includes the following steps.

(1) 0.2 g of first magnetic powder was filled into a mold cavity, a flat copper wire 1 with a rectangular cross section was placed on the surface of the first magnetic powder after the enameled wire was removed, and two ends of the wire 1 were extended out of the mold cavity, wherein the wire 1 was a straight wire 1 with a length of 14 mm, a width of 2.2 mm and a thickness of 0.35 mm. The mold cavity was oscillated, the wire 1 was embedded into the first magnetic powder, and the first magnetic powder was smoothed. Then, 0.3 g of second magnetic powder, 0.5 g of third magnetic powder, 0.3 g of second magnetic powder and 0.2 g of first magnetic powder were sequentially filled, and each time after the magnetic powder was filled, the mold cavity was oscillated and the surface of the magnetic powder was smoothed.

(2) The magnetic powder filled into the mold cavity was molded by cold pressing, wherein a pressure for cold pressing was 1600 Mpa/cm².

(3) After molding, annealing heat treatment was performed in a nitrogen atmosphere to obtain a magnetic core, wherein a temperature for the heat treatment was 690° C., and a time for the heat treatment was 40 min.

(4) Impregnation spraying, bending and tinning were sequentially performed on the wire 1 extending out of the magnetic core to obtain a co-fired inductor with a size of 10.0 mm×5.0 mm×2.0 mm (as shown in FIG. 1), wherein the impregnation treatment was vacuum impregnation, and the spraying solution used in the spraying process was epoxy resin.

The first magnetic powder in step (1) was prepared in the following method.

(a) Insulation coating: the phosphoric acid was diluted by acetone, wherein a mass ratio of the phosphoric acid to the acetone was 1:65; the phosphoric acid and the acetone were mixed and stirred for 5 min and then allowed to stand for 8 min for later use; FeSi soft magnetic powder with D50=20 μm and the diluted phosphoric acid were mixed and stirred for 50 min and then dried at 100° C. for 1.3 h to obtain the phosphated soft magnetic powder.

(b) Secondary coating: a coating material and the soft magnetic powder obtained in step (c) were mixed and stirred for 55 min, wherein the coating material was 7 wt % of the soft magnetic powder, and the coating material was phenolic resin.

(c) Pelletizing treatment: the soft magnetic powder obtained after the secondary coating was pelletized in a 50-mesh pelletizer, the pelletized soft magnetic powder was basked for 2.5 h, the basked soft magnetic powder was sieved through a 40-mesh sieve, dried at 63° C. for 1.1 h, naturally cooled and sieved through a 40-mesh sieve, and magnesium oxide was added to the sieved soft magnetic powder to obtain the first magnetic powder.

The second magnetic powder was prepared with the same operation steps and process parameters as the first magnetic powder. The difference is that the soft magnetic powder adopted in step (a) was replaced with FeNi soft magnetic powder with D50=10 Insulation coating, secondary coating and pelletizing treatment were also sequentially performed on the FeNi soft magnetic powder to obtain the second magnetic powder, and the process parameters adopted in each operation step were completely the same.

The third magnetic powder was prepared with the same operation steps and process parameters as the first magnetic powder. The difference is that the soft magnetic powder adopted in step (a) was replaced with FeSiAl magnetic powder. Insulation coating, secondary coating and pelletizing treatment were also sequentially performed on the FeSiAl magnetic powder to obtain the third magnetic powder, and the process parameters adopted in each operation step were completely the same.

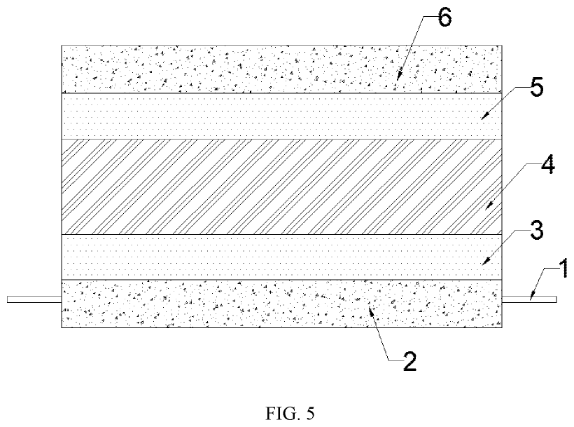

As shown in FIG. 5, in the prepared co-fired inductor, the first magnetic powder layer 2, the second magnetic powder layer 3, the third magnetic powder layer 4, the fourth magnetic powder layer 5 and the fifth magnetic powder layer 6 were formed by sequentially filling the first magnetic powder, the second magnetic powder, the third magnetic powder, the second magnetic powder and the first magnetic powder into the mold cavity, respectively, and the wire 1 was located in the first magnetic powder layer 2. The inductance characteristics of the prepared co-fired inductor were tested. The tested initial inductance L(0 A) was 165 nH, the saturation current was 105 A, and the temperature rise current was 90 A. The efficiency was tested by a 12 V-1 V step-down circuit. When the frequency of the switching power supply was 500 kHz, the efficiency reached 82.0% when the electronic load was 5 A, and the efficiency reached 91.5% when the electronic load was 25 A.

### Comparative Example 1

This example provides a preparation method of an integrated co-fired inductor. The preparation method specifically includes the following steps.

(1) 1 g of magnetic powder was filled into a mold cavity, and a flat copper wire 1 with a rectangular cross section was embedded into the magnetic powder after the enameled wire was removed, wherein the wire 1 was a straight wire 1 with a length of 14 mm, a width of 2.6 mm and a thickness of 0.3 mm.

(2) The magnetic powder filled into the mold cavity was molded by hot pressing, wherein a pressure for hot pressing was 400 Mpa/cm², a temperature for hot pressing was 160° C., and a time for hot pressing was 25 s.

(3) After molding, annealing heat treatment was performed in a nitrogen atmosphere to obtain a magnetic core, wherein a temperature for the heat treatment was 700° C., and a time for the heat treatment was 30 min.

(4) Impregnation spraying, bending and tinning were sequentially performed on the wire 1 extending out of the magnetic core to obtain a co-fired inductor with a size of 11.0 mm×5.0 mm×2.0 mm, wherein the impregnation treatment was vacuum impregnation, and the spraying solution used in the spraying process was epoxy resin.

The magnetic powder in step (1) was prepared in the following method.

(a) Insulation coating: the phosphoric acid was diluted by acetone, wherein a mass ratio of the phosphoric acid to the acetone was 1:60; the phosphoric acid and the acetone were mixed and stirred for 1 min and then allowed to stand for 5 min for later use; FeSi soft magnetic powder with D50=20 μm and the diluted phosphoric acid were mixed and stirred for 30 min and then dried at 90° C. for 1 h to obtain the phosphated soft magnetic powder.

(b) Secondary coating: a coating material and the soft magnetic powder obtained in step (c) were mixed and stirred for 40 min, wherein the coating material was 2 wt % of the soft magnetic powder, and the coating material was phenolic resin.

(c) Pelletizing treatment: the soft magnetic powder obtained after the secondary coating was pelletized in a 40-mesh pelletizer, the pelletized soft magnetic powder was basked for 2 h, the basked soft magnetic powder was sieved through a 30-mesh sieve, dried at 50° C. for 0.8 h, naturally cooled and sieved through a 30-mesh sieve, and magnesium oxide was added to the sieved soft magnetic powder to obtain the magnetic powder.

The inductance characteristics of the prepared co-fired inductor were tested. The tested initial inductance L(0 A) was 140 nH, the saturation current was 50 A, and the temperature rise current was 40 A. The efficiency was tested by a 12 V-1 V step-down circuit. When the frequency of the switching power supply was 500 kHz, the efficiency reached 82.3% when the electronic load was 5 A, and the efficiency reached 88.3% when the electronic load was 25 A.

1. A preparation method of an integrated co-fired inductor, comprising:
filling magnetic powder into a mold cavity in batches, wherein adjacent two layers of magnetic powder are of different types, embedding at least one wire into one layer of magnetic powder, extending two ends of the wire out of the mold cavity, sequentially performing compression molding and heat treatment to obtain a magnetic core, and bending and tinning the wire extending out of the magnetic core to obtain a co-fired inductor.

2. The preparation method according to claim 1, wherein the magnetic powder is prepared by sequentially performing insulation coating, secondary coating and pelletizing treatment on soft magnetic powder to obtain the magnetic powder.

3. The preparation method according to claim 2, wherein the soft magnetic powder comprises FeSiCr, FeSi, FeNi, FeSiAl, carbonyl iron powder, carbonyl iron nickel powder, FeNiMo, a Fe-based amorphous nanocrystalline material, a Co-based amorphous nanocrystalline soft magnetic material or a Ni-based amorphous nanocrystalline soft magnetic material.

4. The preparation method according to claim 2, wherein a coating process used for the insulation coating comprises phosphating, acidifying, oxidizing or nitriding, and further preferably, the insulation coating is performed on the soft magnetic powder by phosphating treatment;
preferably, the phosphating treatment comprises: mixing and stirring the soft magnetic powder and diluted phosphoric acid, and drying the mixture to obtain phosphated soft magnetic powder;
preferably, the phosphoric acid is diluted with acetone;
preferably, a mass ratio of the phosphoric acid to the acetone is 1:(60-70);
preferably, the phosphoric acid and the acetone are mixed and stirred for 1-6 min and allowed to stand for 5-10 min for later use;
preferably, the soft magnetic powder and the diluted phosphoric acid are mixed and stirred for 30-60 min;
preferably, a temperature for drying is 90-110° C.;
preferably, a time for drying is 1-1.5 h.

5. The preparation method according to claim 2, wherein the secondary coating comprises: mixing and stirring a coating material and the soft magnetic powder obtained after insulation coating;
preferably, the coating material is 2-10 wt % of the soft magnetic powder;
preferably, the coating material comprises phenolic resin, epoxy resin or silicone resin;
preferably, the coating material and the soft magnetic powder are mixed and stirred for 40-60 min.

6. The preparation method according to claim 2, wherein the pelletizing treatment comprises: pelletizing the soft magnetic powder obtained after the secondary coating, and basking, drying and cooling the pelletized soft magnetic powder to obtain the magnetic powder;
preferably, the pelletizing is performed in a 40-60-mesh pelletizer;
preferably, a time for basking is less than or equal to 3 h;
preferably, the soft magnetic powder after basking is sieved through a 30-50-mesh sieve and subsequently subjected to drying treatment;
preferably, a temperature for drying is 50-70° C.;
preferably, a time for drying is 0.8-1.2 h;
preferably, the cooling is natural cooling;
preferably, the soft magnetic powder after cooling is sieved through a 30-50-mesh sieve, and an auxiliary material is added to the sieved soft magnetic powder to obtain the magnetic powder;
preferably, the auxiliary material comprises magnesium oxide, lubricating powder or release powder.

7. The preparation method according to claim 1, wherein first magnetic powder, second magnetic powder and the first magnetic powder are sequentially filled into the mold cavity in three batches;
preferably, the wire is embedded into the second magnetic powder.

8. The preparation method according to claim 1, wherein the wire is a bare wire without enameled wire;
preferably, the wire is a copper wire;
preferably, the wire is a flat wire with a rectangular cross section;
preferably, the wire is a straight wire or a shaped wire;
preferably, a shape of the shaped wire comprises an S shape, an L shape, a U shape, a W shape or an E shape;
preferably, the wire is laid side-by-side horizontally at intervals in one layer of magnetic powder.

9. The preparation method according to claim 1, wherein the compression molding is performed by hot pressing or cold pressing;
preferably, a pressure for hot pressing is greater than or equal to 800 Mpa/cm2, further preferably 2000 MPa/cm2;
preferably, a temperature for hot pressing is 90-180° C.;
preferably, a time for hot pressing is 5-100 s;
preferably, the heat treatment is annealing treatment;
preferably, the heat treatment is performed in a protective atmosphere;
preferably, a gas used for the protective atmosphere is nitrogen and/or an inert gas;
preferably, a temperature for the heat treatment is 650-850° C.;
preferably, a time for the heat treatment is 30-50 min.

10. A co-fired inductor prepared by the preparation method according to claim 1, wherein the co-fired inductor comprises a magnetic core and at least one wire located in the magnetic core, the magnetic core comprises at least two magnetic powder layers sequentially stacked, magnetic powder in adjacent two magnetic powder layers is of different types, the wire is located in one magnetic powder layer, two ends of the wire extend out of the magnetic core, and the wire extending out of the magnetic core is bent to adhere to the outer wall of the magnetic core.

11. The co-fired inductor according to claim 10, wherein the wire is a bare wire without enameled wire;
preferably, the wire is a copper wire;
preferably, the wire is a flat wire with a rectangular cross section;
preferably, the wire is a straight wire or a shaped wire;
preferably, a shape of the shaped wire comprises an S shape, an L shape, a U shape, a W shape or an E shape;
preferably, the wire is laid side-by-side horizontally at intervals in one layer of magnetic powder.
